(19) United States
(12) Patent Application Publication
(10) Pub. No.: US 2005/0232303 A1
(43) Pub. Date: Oct. 20, 2005

(54) Efficient packet processing pipeline device and method

(76) Inventors: Koen Deforche, Roeselare (BE); Geert Verbruggen, Zelik (BE); Luc De Coster, Leuven (BE); Johan Wouters, Ham (BE)

Correspondence Address: GORDON & JACOBSON, P.C., 60 LONG RIDGE ROAD, SUITE 407, STAMFORD, CT, 06902, US

(21) Appl. No.: 10/512,334

(22) PCT Filed: Apr. 25, 2003
(86) PCT No.: PCT/US03/14259

§ 371 Date: Oct. 20, 2004

(30) Foreign Application Priority Data
Apr. 26, 2002 (GB) 0209670.9

(51) Int. Cl. H04J 3/24; H04J 3/22; H04J 3/16

(52) U.S. Cl. 370/469; 370/474

(57) ABSTRACT

A packet processing apparatus for processing data packets for use in a packet switched network includes means for receiving a packet, means for adding administrative information to a first data portion of the packet, the administrative information including at least an indication of at least one process to be applied to the first data portion, and a plurality of parallel pipelines, each pipeline comprising at least one processing unit, wherein the processing unit carries out the process on the first data portion indicated by the administrative information to provide a modified first data portion. According to a method, the tasks performed by each processing unit are organized into a plurality of functions such that there are substantially only function calls and no interfunction calls and that at the termination of each function called by the function call for one processing unit, the only context is a first data portion.

### FIELD OF THE INVENTION

The present invention relates to telecommunications networks, especially packet switched telecommunications networks and particularly to network elements and communication modules therefor, and methods of operating the same for processing packets, e.g. at nodes of the network.

### STATE OF THE ART

Dealing with the processing of packets arriving at a high rate at, for instance, a node of a telecommunications network, in a deterministic and flexible way, preferably requires an architecture that takes into account the particularities of dealing with packets, while considering flexible processing elements such as processor cores. Ideal properties of packet processing are inherent parallelism in processing packets, high I/O (input/output) requirements in both the data plane and control plane (on which a single processing thread can stall) and extremely small cycle budgets which need to be used as efficiently as possible. Parallel processing is advantageous for packet processing in high throughput packet-switched telecommunications networks in order to increase processing power.

Although processing may be carried on in parallel, certain resources which need to be accessed are not duplicated. This results in more than one processing element wishing to access such a resource. A shared resource, e.g. a database, is one which is accessible by a plurality of processing elements. Each processing element can be carrying out an individual task which can be different from tasks carried out by any other processing element. As part of the task, access to a shared resource may be necessary e.g. to a database to obtain relevant in-line data. When trying to maximize throughput, accesses to shared resources of the processing elements generally have a large latency. If a processing element is halted until the reply from the shared resource is received the efficiency is low. Also resources requiring large storage space are normally located off chip so that access and retrieval times are significant.

Conventionally, optimizing processing on a processing element having for example, a processing core, involves context switching, that is one processing thread is halted and all current data stored in registers is saved to memory in such a way that the same context can be recreated at a later time when the reply from the shared resource is received. However, context switching takes up a large amount of processor resources or alternatively, time if only a small amount of processor resources is allocated to this task.

It is an object of the present invention to provide a packet processing element and a method of operating the same with improved efficiency.

It is a further object of the present invention to provide a packet processing element and a method of operating the same with which context switching involves a low overhead on processing time and/or low allocation of processing resources.

It is a further object of the present invention to provide an efficient packet processing element and a method of operating the same using parallel processing.

### SUMMARY OF THE INVENTION

The present invention solves this problem and achieves a very high efficiency while keeping a simple programming model, without requiring expensive multi-threading on the processing elements and with the possibility to tailor processing elements to a particular function. The present invention relies in part on the fact that, with respect to context switching, typically there is little useful context, or useful context can be reduced to a minimum by judicious task programming, when a shared resource request is launched in a network element of a packet switched telecommunications network. Switching to process another packet does not necessarily require saving the complete state of a processing element. The judicious programming can include organizing the program to be run on each processing element as a sequence of function calls, each call having a context when run on a processing element but requiring no interfunction calls, except for the data in the packet itself.

Accordingly, the present invention provides a method of processing data packets in a packet processing apparatus for use in a packet switched network, the packet processing apparatus comprising a plurality of parallel pipelines, each pipeline comprising at least one processing unit for processing a part of a data packet, the method further comprising: organizing the tasks performed by each processing unit into a plurality of functions such that there are substantially only function calls and no interfunction calls and that at the termination of each function called by the function call for one processing unit, the only context is a first data portion.

The present invention provides a packet processing apparatus for use in a packet switched network, comprising: means for receiving a packet in the packet processing apparatus; means for adding to at least a first data portion of the packet administrative information including at least an indication of at least one process to be applied to the first data portion; a plurality of parallel pipelines, each pipeline comprising at least one processing unit, and the at least one processing unit carrying out the at least one process on the first data portion indicated by the administrative information to provide a modified first data portion.

The present invention also provides a communications module for use in a packet processing apparatus, comprising: means for receiving a packet in the communication module; means for adding to at least a first data portion of the packet administrative information including at least an indication of at least one process to be applied to the first data portion; a plurality of parallel communication pipelines, each communication pipeline being for use with at least one processing unit, and a memory device for storing the first data portion.

The present invention also provides a method of processing data packets in a packet processing apparatus for use in a packet switched network, the packet processing apparatus comprising a plurality of parallel pipelines, each pipeline comprising at least one processing unit, the method comprising: adding to at least a first data portion of the packet administrative information including at least an indication of at least one process to be applied to the first data portion; and the at least one processing unit carrying out the at least one process on the first data portion indicated by the administrative information to provide a modified first data portion.

The present invention also provides a packet processing apparatus for use in a packet switched network, comprising: means for receiving a packet in the packet processing apparatus; a module for splitting each packet received by the packet processing apparatus into a first data portion and a second data portion; means for processing at least the first data portion; and means for reassembling the first and second data portions.

The present invention also provides a method of processing data packets in a packet processing apparatus for use in a packet switched network, comprising splitting each packet received by the packet processing apparatus into a first data portion and a second data portion; processing at least the first data portion; and reassembling the first and second data portions.

The present invention also provides a packet processing apparatus for use in a packet switched network, comprising: means for receiving a packet in the packet processing apparatus; a plurality of parallel pipelines, each pipeline comprising at least one processing element, a communication engine linked to the at least one processing element by a two port memory unit, one port being connected to the communication engine and the other port being connected to the processing element.

The present invention also provides a communications module for use in a packet processing apparatus, comprising: means for receiving a packet in the communications module; a plurality of parallel communication pipelines, each communication pipeline comprising at least one communication engine for communication with a processing element for processing packets and a two port memory unit, one port of which being connected to the communication engine.

The present invention also provides a packet processing unit for use in a packet switched network, comprising: means for receiving a data packet in the packet processing unit; a plurality of parallel pipelines, each pipeline comprising at least one processing element for carrying out a process on at least a portion of a data packet, a communication engine connected to the processing element, and at least one shared resource, wherein the communication engine is adapted to receive a request for a shared resource from the processing element and transmit it to the shared resource. The communication engine is also adapted to receive a reply from the shared resource(s).

The present invention also provides a communication module for use with a packet processing unit, comprising: means for receiving a data packet in the communication module; a plurality of parallel pipelines, each pipeline comprising at least a communication engine having means for connection to a processing element, and at least one shared resource, wherein the communication engine is adapted to receive a request for a shared resource and transmit it to the shared resource and for receiving a reply from the shared resource and to transmit it to the means for connection to the processing element.

The present invention will now be described with the help of the following drawings.

### BRIEF DESCRIPTION OF THE FIGURES

FIGS. 1a and 1b show a packet processing path in accordance with an embodiment of the present invention.

FIGS. 2a and b show dispatch operations on a packet in accordance with an embodiment of the present invention.

FIG. 3 shows details of one pipeline in accordance with an embodiment of the present invention.

FIG. 4a shows the location of heads in a FIFO memory associated with a processing unit in accordance with an embodiment of the present invention.

FIG. 4b shows a head in accordance with an embodiment of the present invention.

FIG. 5 shows a processing unit in accordance with an embodiment of the present invention.

FIG. 6 shows how a packet is processed through a pipeline in accordance with an embodiment of the present invention.

FIG. 7 shows packet realignment during transfer in accordance with an embodiment of the present invention.

FIG. 8 shows a communication engine in accordance with an embodiment of the present invention.

FIG. 9 shows a pointer arrangement for controlling a head queue in a buffer in accordance with an embodiment of the present invention.

FIG. 10 shows a shared resource arrangement in accordance with a further embodiment of the present invention.

FIG. 11 shows a flow diagram of processing a packet head in accordance with an embodiment of the present invention.

### DETAILED DESCRIPTION OF THE ILLUSTRATIVE EMBODIMENTS

The present invention will be described with reference to certain embodiments and drawings but the present invention is not limited thereto. The skilled person will appreciate that the present invention has wide application in the field of parallel processing and/or in packet processing in telecommunications networks, especially packet switched telecommunication networks.

One aspect of the present invention is a packet processing communication module which can be used in a packet processing apparatus for packet header processing. The packet processing apparatus consists of a number of processing pipelines, each consisting of a number of processing units. The processing units include processor elements, e.g. processors and associated memory. The processors may be microprocessors or may be programmable digital logic elements such as Programmable Array Logic (PAL), Programmable Logic Arrays (PLA), Programmable Gate Arrays, especially Field Programmable Logic Arrays. The packet processing communication module comprises pipelined communication engines which provide non-local communication facilities suitable for processing units. To complete a packet processing apparatus, processor cores and optionally other processing blocks are installed on the packet processing communication module. The processor cores do not need to have a built-in local hardware context switching facility.

In the following the present invention will be described mainly with respect to the completed packet processing apparatus, however it should be understood that the type and size of the processor cores used with a packet processing communication module in accordance with the present invention is not necessarily a limitation on the present invention and that the communications module (without processors) is also an independent aspect of the present invention.

One aspect of the present invention is an optimized software/hardware partitioning. For example, the processing elements are preferably combined with a hardware block called the communication engine, which is responsible for non-local communication. This hardware block may be implemented in a conventional way, e.g. as a logic array such as a gate array. However, the present invention may be implemented by alternative arrangements, e.g. the communication engine may be implemented as a configurable block such as can be obtained by the use of programmable digital logic elements such as Programmable Array Logic (PAL), Programmable Logic Arrays (PLA), Programmable Gate Arrays, especially Field Programmable Logic Arrays. In particular, in order to provide product as soon as possible the present invention includes an intelligent design strategy over two or more generations whereby in the first generation programmable devices are used which are replaced in later generations with dedicated hardware blocks.

Hardware blocks are preferably used for protocol independent functions. For protocol dependent functions it is preferred to use software blocks which allow reconfiguration and reprogramming if the protocol is changed. For example, a microprocessor may find advantageous use for such applications.

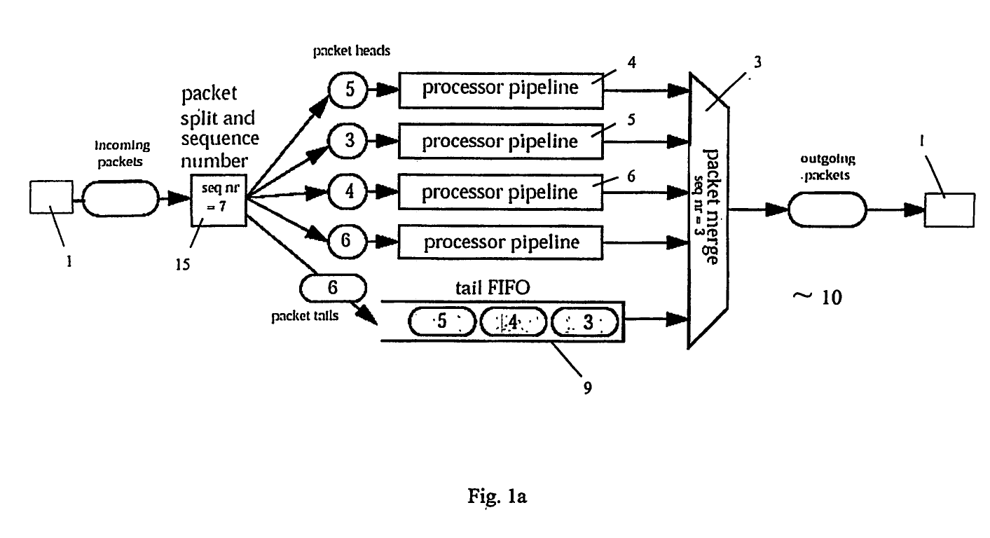

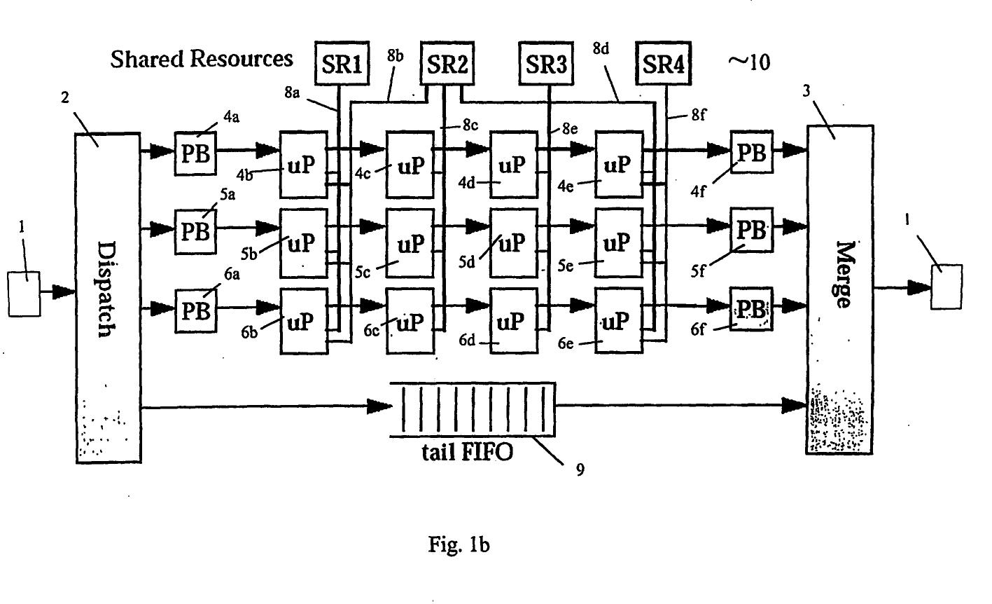

A completed packet processing apparatus 10 according to an embodiment of the present invention comprises a packet processing communication module with installed processors. The processing apparatus 10 has a packet processing path as shown in FIG. 1a consisting of a number of parallel processing pipelines 4, 5, 6. The number of pipelines depends on the processing capacity which is to be achieved. As shown in FIG. 1b the processing path comprises a dispatch unit 2 for receiving packets, e.g. from a telecommunications network 1 and for distributing the packets to one or more of the parallel processing pipelines, 4, 5, 6. The telecommunications network 1 can be any packet switched network, e.g. a landline or mobile radio telecommunications network. Each received packet comprises a header and a payload. Each pipeline 4, 5, 6 comprises a number of processing units 4b . . . e; 5b . . . e; 6b . . . e. The processing units are adapted to process at least the headers of the packets. A packet processing unit 4b . . . e, 5b . . . e, 6b . . . e may interface with a number of other circuit elements such as databases that are too big (or expensive) to be duplicated for each processing unit (e.g. routing tables). Similarly, some information needs to be updated or sampled by multiple pipelines (e.g. statistics or policing info). Therefore, a number of so called shared resources SR1-SR4 can be added with which the processing units can communicate. In accordance with an aspect of the present invention a specific communications infrastructure is provided to let processing units communicate with shared resources. Since the shared resources can be located at a distance from the processing units, and because they handle requests from multiple processors, the latencies between a request and an answer can be high. In particular, at least one of the processing units 4b . . . e; 5b . . . e; 6b . . . e has access to one or more shared resources via a single bus 8a, 8b, 8c, 8d, 8e and 8f, e.g. processing units 4b, 5b, 6b with SR1 via bus 8a, processing units 4b, 5b, 6b and 4c, 5c, 6c and 4e, Se, 6e and SR2 via busses 8b, 8c and 8d, respectively. The bus 8 may be any suitable bus and the form of the bus is not considered to be a limitation on the present invention. Optionally, ingress packet buffers 4a, 5a, 6a, and/or egress packet buffers 4f, 5f, 6f may precede and/or follow the processing pipelines, respectively. One function of a packet buffer can be to adapt data path bandwidths. A main task of a packet buffer is to convert the main data path communication bandwidth from the network 1 to the pipeline communication bandwidth. Besides this, some other functions may be provided in a packet buffer, such as overhead insertion/removal and task lookup. Preferably, the packet buffer has the ability to buffer a single head (which includes at least a packet header). It guarantees line speed data transfer at receive and transmit side for bursts as big as one head.

As shown schematically in FIG. 1a, incoming packets, e.g. from a telecommunications network 1, are split into a head and a tail by a splitting and sequence number assigning means which is preferably implemented in the dispatch unit 2. The head includes the packet header, and the tail includes at least a part of the packet payload. The head is fed into one of the pipelines 4-6 whereas the payload is stored (buffered) in a suitable memory device 9, e.g. a FIFO. After being processed, the header and payload are reassembled in a reassembly unit (packet merge) 3 before being output, e.g. where they can be buffered before being transmitted through the network 1 to another node thereof.

Typically, one or more shared resources SR14 are available to the processing path, which handle specific tasks for the processing units in a pipeline. For example, these shared resources can be dedicated lookup engines using data structures stored in off-chip resources, or dedicated hardware for specialized functions which need to access shared information. The present invention is particularly advantageous in increasing efficiency when these shared resource engines which are to be used in a processing system respond to requests with a considerable latency, that is a latency such as to degrade the efficiency of the processing units of the pipeline if each processing unit is halted until the relevant shared resource responds. Typical shared resources which can be used with the present invention are an IP forwarding table, an MPLS forwarding table, a policing data base, a statistics database. For example, the functions that are performed by the pipeline structure assisted by shared resources may be:
IPv4/IPv6 header parsing and forwarding
Multi-field classification
MPLS label parsing and swapping
IpinIP or GRE tunnel termination(s)
MPLS tunnel termination(s)
IPinIP or GRE tunnel encapsulation(s)
MPLS tunnel encapsulation(s)
Metering and statistics collection
Support for ECMP and Trunking
Support for QoS models
   For this purposes, the pipeline structure may be assisted by the following shared resources:
32b or 128b Longest Prefix Matching unit
TCAM Classification device
off-chip DRAM, off-chip SRAM, on-chip SRAM
6B or 18B Exact Match unit
32b or 128b Source Filter (Longest Prefix Match unit)
Metering unit.

One aspect of the use of shared resources is the stall time of processing units while waiting for answers to requests sent to shared resources. In order for a processing unit to abandon one currently pending task, change to another and then return to the first, it is conventional to provide context switching, that is to store the contents of registers of the processor element. An aspect of the present invention is the use of hardware accelerated context switching. This also allows a processor core to be used for the processing element which is not provided with its own hardware switching facility. This hardware is preferably provided in each processing node, e.g. in the form of a communication engine. Each processing unit maintains a pool of packets to be processed. When a request to a shared resource is issued, a processing element of the relevant processing unit switches context to another packet, until the answer on the request has arrived. One aspect of the present invention is to exploit packet processing parallelism in such a way that the processing units can be used as efficiently as possible doing useful processing, thus avoiding waiting for I/O (input/output) operations to complete. These I/O operations are, for example, requests to shared resources or copying packet information in and out of the processing element. The present invention relies in part on the fact that typically there is little useful context, or useful context can be reduced to a minimum by judicious task programming, when a shared resource request is launched in a network element of a packet switched telecommunications network. Switching to process another packet does not necessarily require saving the complete state of a processing element. The judicious programming can include organizing the program to be run on each processing element as a sequence of function calls, each call having a context when run on a processing element but requiring no interfunction calls. The exception is context provided by the data in the packet itself or in a part of the packet.

Returning to FIGS. 1a and b and the splitting means 15, the size of the head is chosen such that it contains all relevant headers that have been received with the packet. This can be done, for example, by splitting at a fixed point in the packet (after the maximum sized header supported). This can result in some of the payload being split off to the head. Generally, this does not matter as the payload is usually not processed. However, the present invention includes the possibility of the payload being processed, for instance for network rate control. When the packet data contains multi-resolutional data, the data can, when allowed, be truncated to a lower resolution by the network depending upon the bandwidth of the network forward of the node. To deal with such cases, the present invention includes within its scope more accurate evaluation of the packet to recognize header and payload and to split these cleanly at their junction. The separated head (or header) is fed into a processing pipeline, while the tail (or payload) is buffered (and optionally processed using additional processing elements not shown) and reattached to the (modified) head after processing.

After splitting, the head is then supplied to one of the processing pipelines, while the tail is stored into a memory such as a FIFO 9. Each packet is preferably assigned a sequence number by the sequence number assigning module 15. This sequence number is copied into the head as well as into the tail of each packet and stored. It may be used for three purposes:
to reassemble a (modified) head and tail at the end of a pipeline
to delete a head and its corresponding tail if this is required
to keep packets in an specific order when this is required.

The sequence number can be generated, for example, by a counter included in the packet splitting and sequence number assigning means 15. The counter increments with each incoming packet. In that way, the sequence number can be used to put packets in a specific order at the end of the pipelines.

An overhead generator is provided in the packet dispatcher 2 or more preferably in the packet buffer 4a, 5a, 6a generates new/additional overhead for each head and/or tail. After the complete head has been generated, the head is sent to one of the pipelines 4-6 that has buffer space available. The tail is sent to the tail FIFO 9.

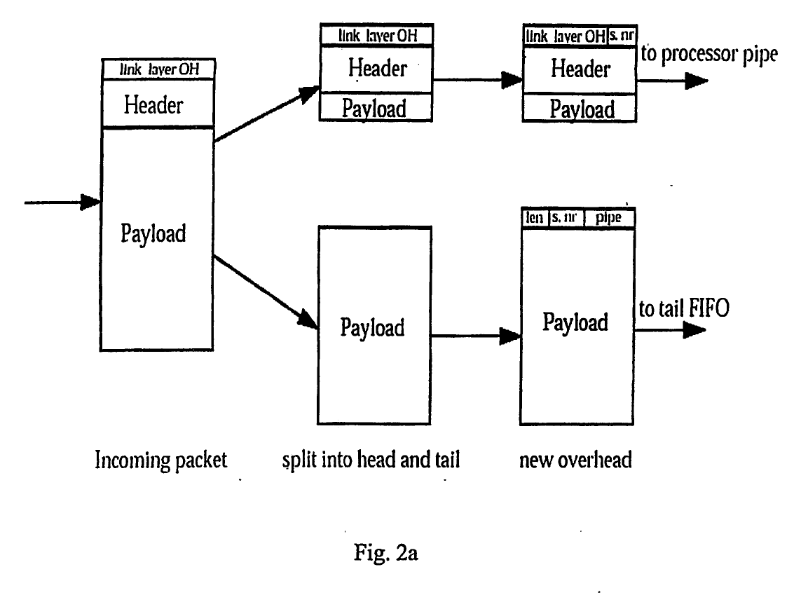

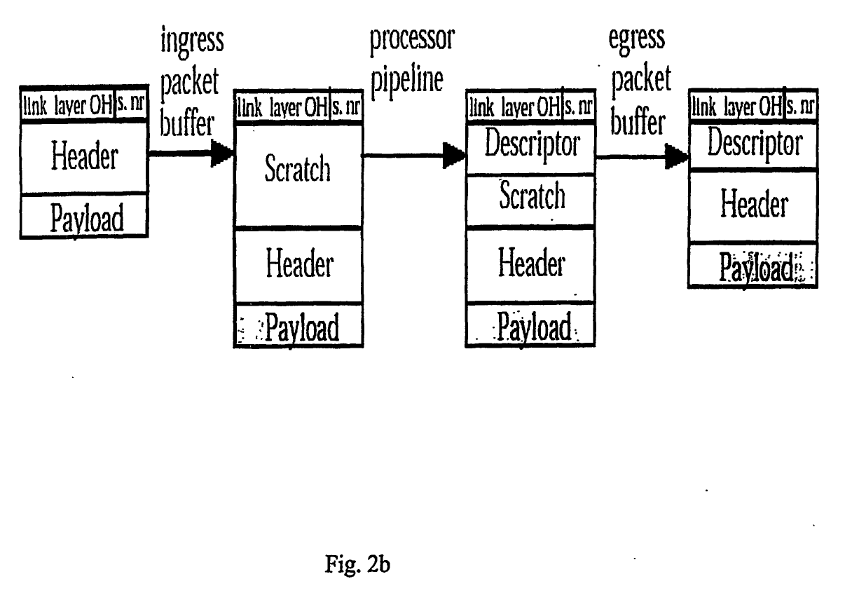

In accordance with an embodiment of the present invention, the added overhead includes administrative data in both the head and/or the tail. A process flow is shown schematically in FIG. 2a. In the tail, the new overhead preferably contains the sequence number and a length, i.e. the length of the payload, and may optionally include a reference to the pipeline used to process the corresponding head. In the head, the added overhead preferably includes a Head Administration Field (HAF), and an area to store results and status generated by the packet processing pipeline. Thus, a head can comprise a result store, a status store, and administrative data store. The HAF can contain head length, offset, sequence number and a number of fields necessary to perform FIFO maintenance and head selection.

FIG. 2b shows an alternative set of actions performed on a packet within the processing apparatus. Each head processed by the pipeline may be preceded by a scratch area which can be used to store intermediate results. It may also be used to build a packet descriptor which can be used by processing devices downstream of the packet processing unit. The packet buffer 4a; 5a, 6a at the beginning of each pipeline can add this scratch area to the packet head. The packet buffer 4f, 5f, 6f at the end removes it (at least partially), as shown in FIG. 2b. When a packet enters the packet processing unit, the header contains some link layer information, defining the protocol of the packet. This has to be translated into a pointer to the first task to be executed on the packet by the packet processing unit. This lookup can be performed by the ingress packet buffer 4a, 5a, 6a.

It is one aspect of the present invention that the head when it is in the pipeline includes a reference to a task to be performed by the current and/or the next processing unit. In this way a part of the context of a processor element is stored in the head. That is, the current version of the HAF in a head is equivalent to the status of the processing including an indication of the next process to be performed on that head. The head itself may also store in-line data, for example intermediate values of a variable can be stored in the scratch area. All information that is necessary to provide a processing unit with its context is therefore stored in the head. When the head is moved down the pipeline, the context moves with the head in the form of the data stored in the relevant parts of the head, e.g. HAF, scratch area. Thus, a novel aspect of the present invention is that the context moves with the packet rather than the context being static with respect to a certain processor.

The packet reassembly module 3 reassembles the packet heads coming from the processing pipelines 4-6 and the corresponding tails coming from the tail FIFO 9. Packet networks may be divided into those in which each packet can be routed independently at each node (datagram networks) and those in which virtual circuits are set up and packets between a source and a destination use one of these virtual circuits. Thus, depending upon the network there may be differing requirements on packet sequencing. The reassembly module 3 assures packets leave in the order they arrive or, alternatively, in any other order as required. The packet reassembly module 3 has means for keeping track of the sequence number of the last packet sent. It searches the outputs of the different processing pipelines for the head having a sequence number which may be sent, as well as the end of the FIFO 9 to see which tail is available for transmission, e.g. the next sequence number. For simplicity of operation it is preferred if the packets are processed in the pipelines strictly in accordance with sequence number so that the heads and their corresponding tails are available at the reassembly module 3 at the same time. Therefore, it is preferred if means for processing packets in the pipelines strictly in accordance with sequence number are provided. Then, after the appropriate head is propagated to the output of the pipeline, it is added in the reassembly module 3 to the corresponding tail, which is preferably the first entry in the tail FIFO 9 at that moment. The reassembly unit 3 or the egress packet buffer 4f, 5f, 6f removes the remaining HAF and other fields from the head.

When a packet must be dropped, a processing unit has a means for setting an indication in the head that a head is to be dropped, e.g. it can set a Drop flag in the packet overhead. The reassembly module 3 is then responsible for dropping this head and the corresponding tail.

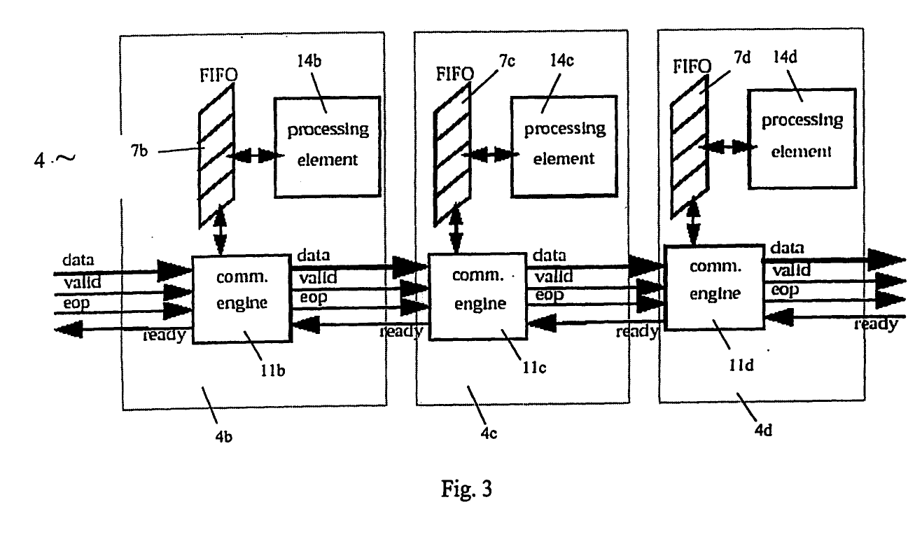

One pipeline 4 in accordance with an embodiment of the present invention is shown schematically in FIG. 3. The packet heads are preferably transferred from one process stage to another, along a number of busses, with minimal intervention of the processing units. Moreover, processing units need to be able to continue processing packets during transport. Preferably, each processing unit 4b . . . 4d comprises a processing element 14b-14d and a communication engine 11b-d. The communication engine may be implemented in hardware, e.g. a configurable digital logic element and the processing element may include a programmable processing core although the present invention is not limited thereto. Some dedicated memory is allocated to each processing unit 4b-d, respectively. For example, a part of the data memory of each processing element is preferably a dual port memory, e.g. a dual port RAM 7b . . . 7d or similar. One port is used by the communication engine 11b . . . d and the other port is connected to the processing element of this processing unit. In accordance with one embodiment of the present invention the communication engine 11b . . . d operates with the heads stored in memory 7b . . . 7d in some circumstances as if this memory is organized as a FIFO. For this purpose the heads may be stored logically or physically as in a FIFO. By this means the heads are pushed and popped from this memory in accordance with their arrival sequence. However, the communication engine is not limited to using the memory 7b . . . 7d in this way but may make use of any capability of this memory, e.g. as a two-port RAM, depending upon the application. The advantage of keeping a first-in-first-out relationship among the headers as they are processed is that the packet input sequence will be maintained automatically which results in the same output packet sequence. However, the present invention is not limited thereto and includes the data memory being accessed by the communication engine in a random manner.

The communication engines communicate with each other for transferring heads. Thus, when each communication engine is ready to receive new data, a ready signal is sent to the previous communication engine or other previous circuit element.

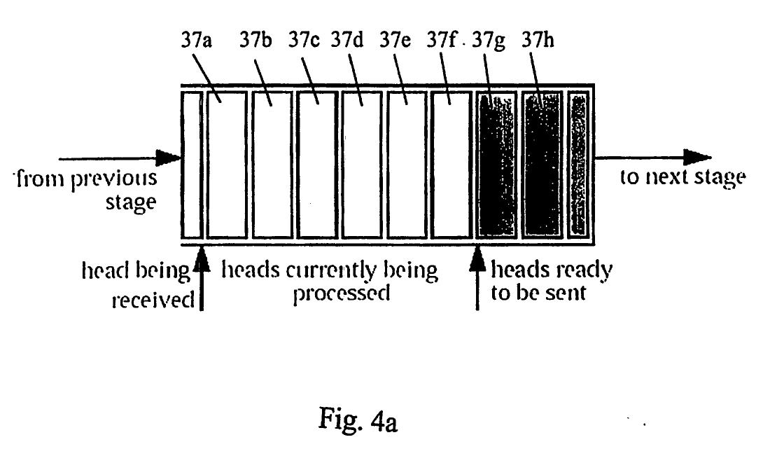

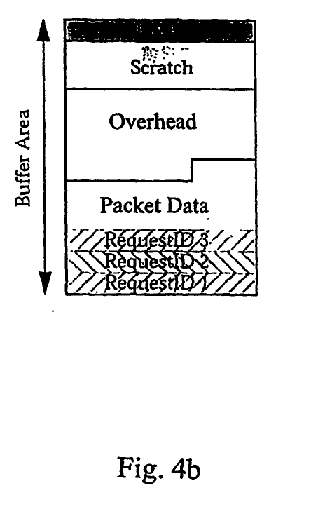

In accordance with an embodiment of the present invention, as shown schematically in FIG. 4a, when moving from the output to the input port of a RAM 7b . . . 7d, three areas of the memory are provided: one containing heads that are processed and ready to be sent to the next stage, another containing heads that are being processed, and a third containing a head that is partially received, but not yet ready to be processed. The RAM 7b . . . 7d is divided in a number of equally sized buffers 37a-h. Each buffer 37a-h contains only one head. As shown schematically in FIG. 4b each head contains:
A Head Administration Field (HAF): the HAF contains all information needed for packet management. It is typically one 64 bit word long. The buffers 37a-h each have means for storing the HAF data.
Scratch Area: an optional area to be used as a scratch pad, to communicate packet state between processors or to build the packet descriptors that will leave the system. The buffers 37a-h each preferably have means for storing the data in the scratch area.
Packet Overhead: overhead to be removed from the packet (decapsulation) or to be added to the packet (encapsulation). The buffers 37a-h each preferably have means for storing the packet overhead.
Head Packet Data: the actual head data of the packet. The buffers 37a-h each preferably have means for storing the head packet data.
Shared Resources Requests: besides a packet, each buffer provides some space for shared resource requests at the end of the buffer. The buffers 37a-h each preferably have means for storing the shared resources requests.

The HAF contains packet information (length), and the processing status as well as containing part of the “layer2” information, if present (being at least, for instance, a code indicating the physical interface type and a “layer3” protocol number).

A communication module in accordance with an embodiment of the present invention may comprise the dispatch unit 2, the packet assembly unit 3, the memory 9, the communication engines 1b . . . d, the dual port RAM 7b-d, optionally the packet buffers as well as suitable connection points to the processing units and to the shared resources. When the communications module is provided with its complement of processing elements a functioning packet processing apparatus is formed.

A processing unit in accordance with an embodiment of the present invention is shown schematically in FIG. 5. A processing unit 4b comprises a processing element 14b, a head buffer memory 7b preferably implemented as a dual-port RAM, a program memory 12b and a communications engine 11b. A local memory 13b for the processing element may be provided. The program memory 12b is connected to the processing element 14b via an instruction bus 16b and is used to store the programs running on the processing element 14b. The buffer memory 7b is connected to the processing element 14b by a data bus 17b. The communication engine 11b monitors the data bus via a monitoring bus 18b to detect write accesses from the processing element to any HAF in one of the buffers. This allows the communication engine 11b to monitor and update the status of each buffer in its internal registers. The communication engine 11b is connected to the buffer memory 7b by a data memory bus 19b. Optionally, one or more processing blocks (not shown) may be included with the processing element 14b, e.g. co-processing devices such as an encryption block in order to reduce load on the processing element 14b for repetitive data intensive tasks.

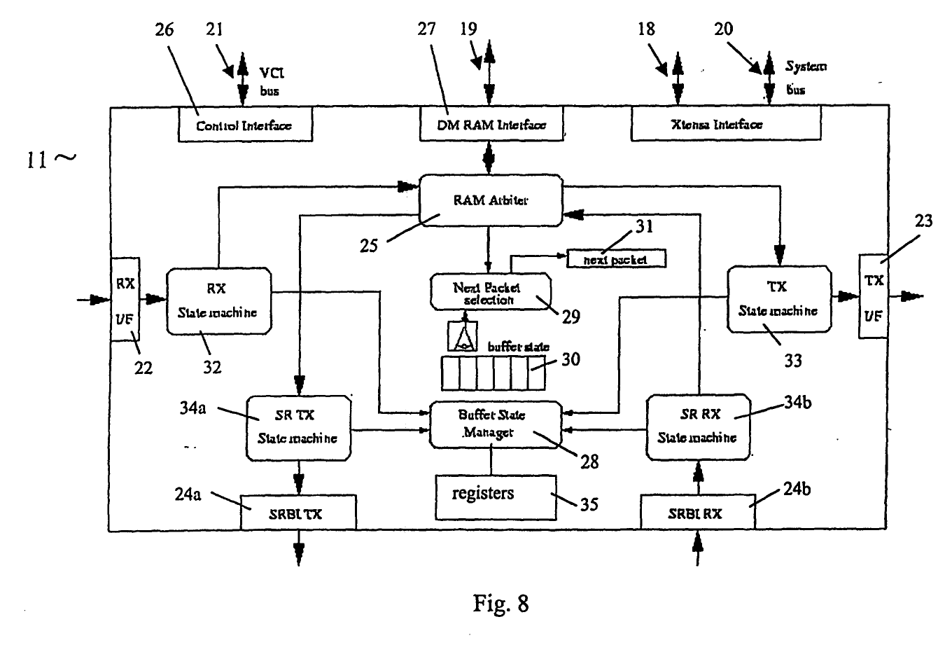

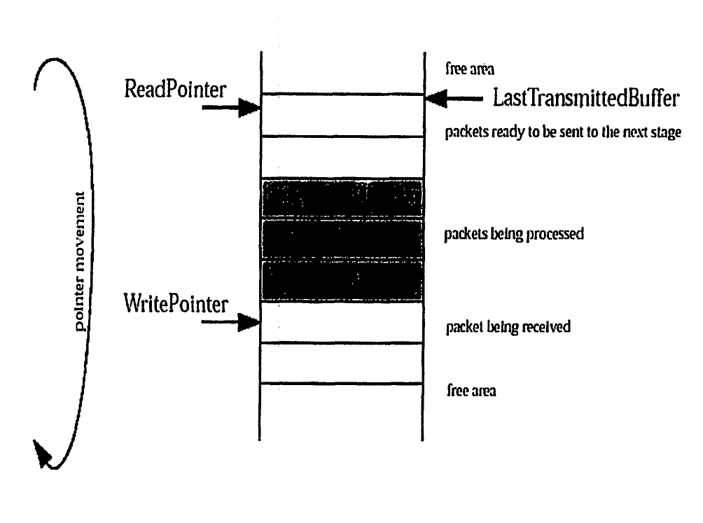

A processing element 14b in accordance with the present invention can efficiently be implemented using a processing core such as an Xtensa® core from Tensilica, Santa Clara, Calif., USA. A processing core with dedicated hardware instructions to accelerate the functions that will be mapped on this processing element make a good trade-off between flexibility and performance. Moreover, the needed processing element hardware support can be added in such a processor core, i.e. the processor core does not require context switching hardware support. The processing element 14b is connected to the communication engine 11b through a system bus 20b—resets and interrupts may be transmitted through a separate control bus (best shown in FIG. 8). From the processing element's point of view, the data memory 7b is not a FIFO, but merely a pool of packets, from which packets can be selected for processing using a number of different selection algorithms.

In accordance with an aspect of the present invention processing elements are synchronized in such a way that the buffers 37a-h do not over- or underflow. Processing of a head is done in place at a processing element. Packets are removed from the system as quickly as they arrive so processing will never create the need for extra buffer space. So, a processing element should not generate a buffer overflow. Processing a packet can only be started when enough data are available. The hardware (communication engine) suspends the processing element when no heads are eligible for processing. The RAM 7b . . . 7d provides buffer storage space and allows the processing elements to be decoupled from the processing pace of the pipeline.

Each processing element can decide to drop a packet or to strip a part of the head or add something to a head. To drop a packet, a processing element simply sets the Drop flag in the HAF. This will have two effects: the head will not be eligible anymore for processing and only the HAF will be transferred to the next stage. When the packet reassembler 3 receives a head having the Drop bit set, it drops the corresponding tail.

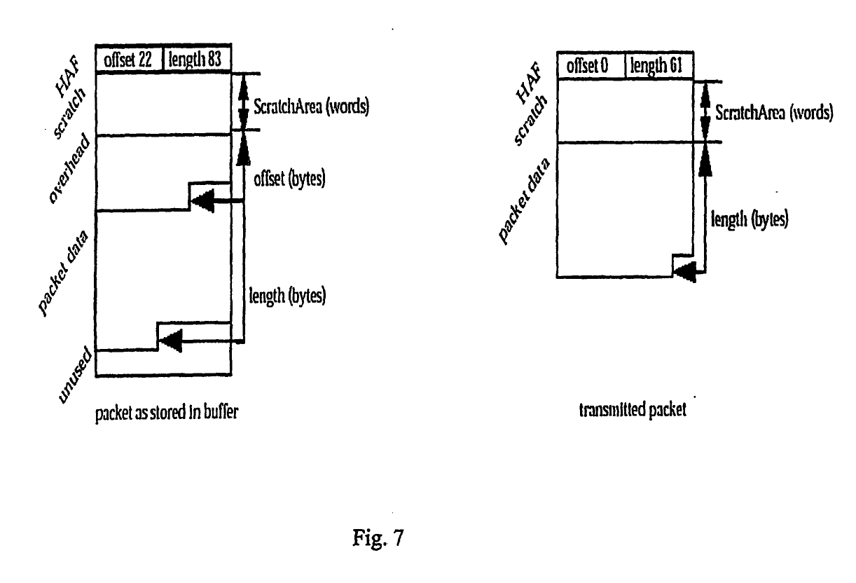

The HAF has an offset field which indicates the location of the first relevant byte. On an incoming packet, this will always be equal to zero. To strip a part of the head at the beginning, the processing element makes the Offset flag point to the first byte after the part to be stripped. The communication engine will remove the part to be stripped, realign the data to word boundaries, update the Length field in the HAF, and put the offset field back to zero. This is shown in FIG. 7. The advantage of this procedure is that the next status to be read by a communication engine is always located at a certain part of the HAF, hence the communication engines (and processing elements) can be configured to access the same location in the HAF to obtain the necessary status information. Also, more space may be inserted in a HAF by negative offset values. Such space is inserted at the front of the HAF.

The dispatching unit 2 can issue a Mark command by writing a non-zero value into a Mark register. This value will be assigned to the next incoming packet, i.e. placed in the head. When the reassembly unit 3 issues a command for this packet (at that moment the head is completely processed), the mark value can result in generation of an interrupt. One purpose of marking a packet is when performing table updates. It may be necessary to know when all packets received before a certain moment, have left the pipelines. Such packets need to be processed with old table data. New packets are to be processed with new table data. Since packet order remains unchanged through the pipelines, this can be accomplished by marking an incoming packet. In packet processing apparatus in which the order is not maintained, a timestamp may be added to each head instead of a mark to one head. Each head is then processed according to its timestamp. This may involve storing two versions of table information for an overlap time period.

Each processing element has access to a number of shared resources, used, for example, for a variety of tasks such as lookups, policing and statistics. This access is via the communications engine associated with each processing element. A number of buses 8a-f are provided to connect the communication engines to the shared resources. The same buses 8a-f are used to transfer the requests as well as the answers. For example, each communication engine 11b is connected to such a bus 8 via a Shared Resource Bus Interface 24b (SRBI—see FIG. 8). The communication engine and the data memory 7b can be configured via a configuration bus 21.

The communication engine 11b is preferably the only way for a processing element to communicate to resources other than its local memory 13b. The communication engine 11b is controlled by the host processing element 14b via a control interface. The main task of the communication engine 11b is to transfer packets from one pipeline stage to the next one. Besides this, it implements context switching and communication with the host processing element 14b and shared resources.

The communication engine 11b has a receive interface 22b (Rx) connected to the previous circuit element of the pipeline and a transmit interface 23b (Tx) connected to the next circuit element in the pipeline. Heads to be processed are transmitted from one processing unit to another via the communications engines and the TX and RX interfaces, 22b, 23b. If a head is not to be processed in a specific processing unit it can be provided with a tunneling field which defines the number of processing units to be skipped.

Each transmit/receive interface 22b, 23b of a communication engine 11b which is receiving and transmitting at the same time, can only access the data memory 7 during less than 50% of the clock cycles. This implies that the effective bandwidth between two processing stages is less than half the bus bandwidth. As long as the number of pipelines is greater than two, this is sufficient. However, the first pipeline stage has to be able to sink bursts at full bus speed when a new packet head enters the pipeline. In a similar way, the last pipeline stage must be able to produce a packet at full bus speed. The ingress packet buffer 4a, 5a, 6a is responsible to equalize these bursts. The ingress packet buffer receives one packet head at bus speed and then sends it to the first processor stage at its own speed. During that period, it is not able to receive a new packet head. The egress packet buffer 4f, 5f, 6f receives a packet head from the last processor stage. When received, it sends the head to the packet reassembly unit 3 at bus speed. The ingress packet buffer can have two additional tasks:
It adds the packet overhead.
It translates Interface Type/Protocol code in the received packet header into a pointer to the first task. The packet “layer2” encapsulation contains a Protocol field, identifying the “layer3” protocol. However, the meaning of this field depends on the “layer2” protocol. The (“layer2” protocol, “layer3” protocol field) pair needs to be translated into a pointer, pointing to the first task to be executed on the packet.

The egress packet buffer has one additional task:
It removes (part of) the packet overhead.

A number of hardware extensions are included in accordance with the present invention to help the FIFO management:
FIFO address bias. Knowing the FIFO location of the head currently being processed, the processing element can modify the read and write addresses, such that the packet appears to be located at a fixed address.
Automatic Head Selection. Upon a simple request of the processing engine, special hardware selects a head that is ready to be processed.
When the communication engine has selected a new head, the processing element can fetch the necessary information using a single read access. This information has to be split into different target registers. (FIFO location, head length, protocol, . . . ).

As indicated above in an aspect of the present invention hardware, such as the communication engine, may be provided to support a very simple multitasking scheme. A “context switch” is done; for example, when a process running on a processing element has to wait for an answer from a shared resource or when a head is ready to be passed to the next stage. The hardware is responsible for selecting a head that is ready to be processed, based on the HAF. Packets are transferred from one stage to another via a simple ready/available protocol or any other suitable protocol. Only the part of a buffer that contains relevant data is transferred. To achieve this the head is modified to contain the necessary information for directing the processing of the heads. In accordance with embodiments of the present invention processing of a packet is split up into a number of tasks. Each task typically handles the response to a request and generates a new request. A pointer to the next task is stored in the head. Each task first calculates and then stores the pointer to the next task. Each packet has a state defined by Done and Ready represented by two bits in various combinations. They have following meaning:
Done=0, Ready=0: the packet is currently waiting for a response from a shared resource. It cannot be selected for processing, nor can it be sent to the processing element of the next processing unit.
Done=0, Ready=1: the packet can be selected for processing on this processing element.
Done=1, Ready=0: the processing on this processing element is done. The packet can be sent to the processing element of the next processing unit.
Done=1, Ready=1: not used

From a buffer management point of view, buffers containing a packet can be in three different states:
Ready to go to the next stage (Ready4Next)
Ready to be processed (Ready4Processing)
Waiting for a shared resource answer (Waiting)

The communication engine maintains the packet state, e.g. by storing the relevant state in a register, and also provides packets in the Ready4Processing state to the processor with which it is associated. After being processed, a packet is in the Ready4Next or Waiting state. In the case of the Ready4Next state, the communication engine will transmit the packet to the next stage. When in the Waiting state, the state will automatically be changed by the communication engine to the Ready4Processing or Ready4Next state when the shared resource answer arrives.

The communication engine is provided to select a new packet head. The selection of a new packet head is triggered by a processing element, e.g. by a processor read on the system bus. A Current Buffer pointer is maintained in a register, indicating the current packet being processed by the processing element.

A schematic representation of a communication engine in accordance with one embodiment of the present invention is shown in FIG. 8. The five main tasks of the communication engine may be summarized as follows:

Buffer Management:

1) Receive side 22 (Rx): receive packets from previous processing node and push onto the dual port RAM 7
2) Transmit side 23 (Tx): pop ready packets from the dual port RAM 7 and transmit to next unit.
   Multi-Tasking (Context-Switching)
3) Select new packet eligible for processing on the basis of buffer states Shared resource access:
4) Transmit side 24a (TX): assemble SR requests on the basis of list of requestIDs
5) Receive side 24b (Rx): process answers of returning SR requests.

The five functions described above have been represented as four finite state machines (FSM, 32, 33, 34a, 34b) and a buffer manager 28 in FIG. 8 It should be understood that this is a functional description of the blocks of the communication engine and does not necessarily relate to actual physical elements. The Finite State machine representation of the communications engine as shown in FIG. 8 can be implemented in a hardware block by standard processing techniques. For example, the representation may be converted into a hardware language such as Verilog or VHDL and a netlist for a hardware block, e.g. a gate array, may then be generated automatically from the VHDL source code.

Main data structures (listed after most involved task) handled by the communication engine are:
buffer management: FIFO-like data structure in buffers of dual port RAM
   receiving head: WritePointer stored in a write pointer register
   transmitting head: ReadPointer stored in a read pointer register
multi-tasking: BufferState vector with State which is one of empty, Ready for transfer, Ready for processing, Ready for transfer pending, Ready for processing pending plus WaitingLevel, all stored in buffer state registers CurrentBuffer in a current buffer register,
   NewPacketRegister: preparing 'HAF and buffer location of next packet to be processed by processor.
SR (shared resource) access: during processing, requests are queued in RAM in the packet buffer area
   Transmit side (23a): maintain SR request FIFO, a buffer that allows further processing while assembly of requests

Others parts of the Communication Engine are:
arbiter 25 to RAM: the many functional units of the Communication Engine share the bus 19 to the RAM 7
configuration interface 26 and configuration field map for the communication engine and the buffers in RAM 7. The control interface 26 may be provided to configure the communication engine, e.g. the registers and random access memory size.
   A port of the data memory 7 is connected to the communication engine 11 via the Data Memory (DM) RAM interface 27 and the bus 19. During normal operation this bus 19 is used to fill the packet buffers 37a-h in memory 7 with data arriving at the RX interface 22 of the communication engine 11, or empty it to the TX interface 23, in both cases via the RAM arbiter 25. The arbiter 25 organizes and prioritizes the access to DM RAM 7 between the functional units (FSMs): SR RX 34b, SR TX 34a, next packet selection 29, Receiving 32, Transmitting 33.

Each processor element 14 has access to a number of shared resources, used for lookups, policing and statistics. A number of buses 8 are provided to connect processing elements 14 to the shared resources. The same bus 8 may be used to transfer the requests as well as the answers. Each communication engine 11 is connected to such a bus via a Shared Resource Bus Interface 24 (SRBI).

Each communication engine 11 maintains a number of packet buffers 37a-h. Each buffer can contain one packet, i.e. has means for storing one packet. With respect to packet reception and transmission, the buffers are dealt with as a FIFO, so packet order remains unaltered. Packets enter from the RX Interface 22 and leave through the TX Interface 23. The number of buffers, buffer size and the start of the buffer area in the data memory 7 are configured via the control interface 26. Buffer size is always a power of 2, and the buffer start is always a multiple of the buffer size. In that way, each memory address can easily be split up in a buffer number and an offset in the buffer. Each buffer can contain the data of one packet. A write access to a buffer by a processing element 14 is monitored by the communication engine 11 via the monitoring bus 18 and updates the buffer state in a buffer state register accordingly. A buffer manager 28 maintains four pointers in registers 35, two of them pointing to a buffer and two of them pointing to a specific word in a buffer:
RXWritePointer: points to the next word that will be written when receiving data. After reset, it points to the first word of the first buffer.
TXReadPointer: points to the next word that will be read when transmitting data. After reset, it points to the first word of the first buffer.
LastTransmittedBuffer: points to the last transmitted buffer, or to the buffer that is being transmitted, i.e. it is updated to point to a buffer as soon as the first word of that buffer is being read. After reset, it points to the last buffer.
CurrentBuffer: points to the buffer that is currently in use by the processor. An associated Current-BufferValid flag indicates whether the content of CurrentBuffer is valid or not. When a process element is not processing any packet, CurrentBufferValid is cleared.
   The various pointers are shown schematically in FIG. 9

For each buffer, a state is maintained in buffer state registers 30. Each buffer is in one of the following five states:
Empty: the buffer does not contain a packet.
ReadyForTransfer: the packet in the buffer can be transferred to the next processor stage.
ReadyForProcessing: the packet in the buffer can be selected for processing by the processor.
ReadyForTransferWSRPending: the packet must go to the ReadyForTransfer state when all Shared Resource requests are transmitted.
ReadyForProcessingWSRPending: the packet must go to the ReadyForProcessing state when all Shared Resource requests are transmitted.

Besides a state, a WaitingLevel is maintained for each buffer in the registers 35. A WaitingLevel different from zero, indicates that the packet is waiting for some event, and should not be handed over to the processor, nor transmitted. Typically, WaitingLevel represents the number of ongoing shared resource requests. After reset, all buffers are in the Empty state. When a packet is received completely, the state of the buffer where it was stored, is updated to ReadyForProcessing state for packets that need to be processed, or to the ReadyForTransfer state for packets that need no processing (e.g. dropped packets). The WaitingLevel for a buffer is set to zero on any incoming packet.

After processing a packet, the processor 14 updates the buffer state of that packet, by writing the Transfer and SRRequest bit into the HAF, i.e. into the relevant buffer of the dual port RAM 7. This write is monitored by the communication engine 11 via the monitoring bus 18. The processor 14 can put a buffer in a ReadyForProcessing or ReadyFor-Transfer state if there are no SR requests to be sent, or to the ReadyForTransferWSRPending or ReadyFor-ProcessingWSRPending states if there are requests to be sent. From the ReadyForTransferWSRPending or ReadyForProcessingWSRPending states, the buffer state returns to ReadyForTransfer or ReadyForProcessing as soon as all requests are transmitted. When the ReadPointer reaches the start of a new buffer, it waits until that buffer gets into the Ready-ForTransfer state and has WaitingLevel equal to zero, before reading and transmitting the packet. As soon as the transmission starts, the buffer state is set to Empty. This guarantees that the packet cannot be selected anymore. (Untransmitted data can not be overwritten even if the buffer is in the Empty state, because the WritePointer will never pass the ReadPointer).

As long as there are empty buffers, incoming data are accepted from the RX interface. The buffer area is full when WritePointer reaches ReadPointer (an extra flag is needed to make the distinction between full and empty, since in both conditions, ReadPointer equals WritePointer).

Packet transmission is triggered when the buffer ReadPointer points to, gets into the ReadyForTransfer state and has a WaitingLevel of zero. First, the buffer state is set to Empty, Then, the HAF and the scratch area are read from the RAM and transmitted. The words that contain only overhead to be stripped are skipped. Then the rest of the packet data is read and realigned before transmission, such that the remaining overhead bytes in the first word are removed. However if a packet has its Drop flag set, the packet data is not read. After a packet is transmitted, ReadPointer jumps to the start of the next buffer.

The communication engine maintains the CurrentBuffer pointer, pointing to the buffer of the packet currently being processed by the processing element. An associated Valid flag indicates that the content of Current-Buffer is valid. If the processor is not processing any packet, the Valid flag is set to false. Five different algorithms are provided to select a new buffer:
FirstPacket (0): returns the buffer containing the oldest packet.
NextPacket (1): returns the first buffer after the current buffer containing a packet. If there is no current buffer, behaves like FirstPacket.
FirstProccesablePacket (2): returns the buffer containing the oldest packet in the ReadyForProcessing state.
NextProcessablePacket (3): returns the first buffer after the current buffer containing a packet in the ReadyForProcessing state. If there is no current buffer, behaves like FirstProcessablePacket.
NextBuffer (4): returns the first buffer after the current buffer. If there is no current buffer, returns the first buffer.

When a processor has finished processing a buffer, it specifies what the next task is that has to be done on the packet. This is done by writing the following fields in the packets HAF:
Task: a pointer to the next task.
Tunnel: set if the next task is not on this or on the next processor.
Drop: set if the packet needs to be dropped. Overrides Task and Tunnel.
Transfer: set if the next task is on another processor, cleared if the next task is on the same processor.
SRRequest: set if shared resource accesses have to be done before switching to the next task.

The Transfer and SRRequest bits are not only written into the memory, but also monitored by the communication engine via the XLMI interface. This is used to update the buffer state:
SRRequest=0 and Transfer=0: ReadyForProcessing
SRRequest=0 and Transfer=1: ReadyForTransfer
SRRequest=1 and Transfer=0: ReadyForProcessingWSRPending
SRRequest=1 and Transfer=1: ReadyForTransferWSRPending

The communication engine 11 provides a generic interface 24 to shared resources. A request consists of a header followed by a block of data sent to the shared resource. The communication engine 11 generates the header in the SRTX 34a, but the data has to be provided by the processor 14. Depending on the size and nature of the data to be sent, three ways of assembling the request can be distinguished:
Immediate: the data to be sent are part of the RequestID. This works for requests containing only small amounts of data. The reply on the request is stored at a position indicated by the Offset field in the RequestID (offset), or to a default offset (default).
Memory: the data to be sent are stored in the memory. The RequestID contains location and size of the data. Two request types are provided: one where the data are located in the packet buffer (relative), and one where the location points to an absolute memory address (absolute). An offset field indicates where the reply must be stored in the buffer.
Sequencer: a small sequencer collects data from all over the packet and builds the request. The RequestID contains a pointer to the start of the sequencer program. An offset field indicates where the reply must be stored in the buffer.

The SR RequestID may contain the following fields:
RequestType: determines the type of the request as discussed above.
Resource: ID of the resource to be addressed
SuccessBit: the index of the success bit to be used (see below)
Command: if set, this indicates that no reply is expected from this request. If cleared an answer is expected.
Last: set for the last RequestID for the packet. Cleared for other RequestID's.
Offset: position in the buffer where the reply of the request must be stored. The offset is in bytes, starting from the beginning of the buffer.
EndOffset: if set, indicates that the Offset indicates where the end of the reply must be positioned. Offset then points to the first byte after the reply. If cleared, Offset points to the position where the first byte of the reply must be stored.
Data: data to be transmitted in the request, for an immediate request.
Address: location where the data to be transmitted are located (absolute or relative to the start of the packet buffer), for a memory request.
Length: number of words to be transmitted, for a memory request.
Program: start address of the program to be executed by the sequencer

After putting the RequestID's in the buffer memory 7, the processor indicates the presence of these IDs by setting the SRRequest bit in the HAF (this is typically done when the HAF is updated for the next task).

When the processor releases a buffer (by requesting a new one), the SRRequest bit in the HAF is checked. This can be done by evaluating the buffer state. If set, the buffer number of this packet is pushed into a small FIFO, the SRRequest FIFO. When this FIFO is full, the Idle task is returned on a request for a new packet, to avoid overflow. The SR TX state machine 34a (FIG. 8) pops buffer numbers from the SRRequest FIFO. It then parses the RequestIDs in the buffer, starting at the highest address, until a RequestID is encountered that has its Last bit set. Then the next buffer number is popped from the FIFO, until no entries are available anymore. Each time a RequestID is parsed, the corresponding request is put together and sent to the SRBI bus 24a. When the SRRequest bit of a HAF is set, the corresponding buffer state is set to ReadyForTransferWSRPending or ReadyForProcessingWSRPending, depending on the value of the Transfer bit. As long as the buffer is in one of these states, it is not eligible for being transmitted or processed.

Whenever a non-command request is transmitted, the WaitLevel field is incremented by one. When a reply is received, it is decremented by one. When all requests are transmitted, the buffer state is set to ReadyForTransfer (when coming from ReadyForTransferWSRPending) or ReadyForProcessing (when coming from ReadyForProcessingWSRPending). This mechanism guarantees that a packet can only be transmitted or processed (using the Next/First-ProcessablePacket algorithm) not earlier than the moment where
all requests are transmitted
all replies for transmitted requests have arrived.

The destination address of a reply is decoded by the shared resource bus socket. Replies that match the local address are received by the communication engine over the SRBI RX interface 24b. The reply header contains a buffer number and offset where the reply has to be stored. Based on this, the communication engine is able to calculate the absolute memory address. The data part of the reply is received from the SRBI bus 8 and stored into the data memory 7. When all data are stored, the success bits (see below) are updated by performing a read-modify-write on the HAF in the addressed buffer, and finally the WaitLevel field of that buffer is decremented by one.

Some of the shared resource requests can end with a success or failure status (e.g. Exact Match resource compares an address to a list of addresses. A match returns an identifier, no match returns a failure status). Means are added to propagate this to the HAF of the involved packet. A number of bits, e.g. five, are provided in the HAF which can catch the result of different requests. Therefore it is necessary that a RequestID specifies which of the five bits has to be used. Shared resources can also be put in a chain, i.e. the result of a first shared resource is the request for a second shared resource and so on. Each of these shared resources may have a success or failure status and thus may need its own success bit. It is important to note that the chain of requests is discontinued when a resource terminates with a failure status. In that case the failing resource sends its reply directly to the originating communication engine.

While processing a packet, the processing element 14 associated with a communication engine 11 can make the communication engine 11 issue one or more requests to the shared resources, by writing the necessary RequestID's into the relevant packet's buffer. Each RequestID is, for example, a single 64 bit word, and will cause one shared resource request to be generated. Replies from a shared resource are also stored in the packet's buffer. The process of assembling and transmitting the requests to shared resources is preferably started when the packet is not being processed any more by the processor. The packet can only become selectable for processing again after all replies from the shared resources have arrived. This guarantees that a single buffer will never be modified by the processor and the communication engine at the same time.

A shared resource request is invoked by sending out the request information together with information for the next action from a processing element to the associated communications engine. This is a pointer identifying the next action that needs to be performed on this packet, and an option to indicate that the packet needs to be transferred to the next processing unit for that action. Next, the processing unit reads the pointer to the action that needs to be performed next. This selection is done by the same dedicated hardware, e.g. the communication engine, which regulates the copying of heads into and out of the buffer memory 7 for the processing element relating to the processing unit. To this extent, the communication engine also processes the answers from the shared resources. A request to a shared resource preferably includes a reference to the processing element which made the request. When the answer returns from the shared resource, the answer includes this reference. This allows the receiving communication engine to write the answer into the correct location into the relevant head in its buffer. Subsequently, the processing element jumps to the identified action. In this way, the processing model is that of a single thread of execution. There is no need for an expensive context switch that needs to save all processing element states, an operation that may either be expensive in time or in hardware. Moreover, it trims down the number of options for the selection of such a processing element. The single thread of execution is in fact an endless loop of:
1. Reading action information
2. Jumping to that action
3. Formulating a request to a shared resource or indicating hand-off of the packet to the next stage
4. Back to 1.
   This programming model thus strictly defines the subsequent actions which will be performed on a single packet, together with the stage in which these actions will be performed. It does not define the order of (action, packet) tuples which are performed on a single processing element. This is a consequence of timing and latency of the shared resources, and exact behavior as such is transparent to the programming model.

The rigid definition of this programming model allows a verification of the programming code of the actions performed on the packets on a level which does not need to include the detail of these timing and latency figures.

A further embodiment of the present invention relates to how the shared resources are accessed. Processing units and shared resources are connected via a number of busses, e.g. double 64 bit wide busses. Each node (be it a processing unit or a shared resource) has a connection to one or more of these busses. The number of busses and number of nodes connected to each bus are determined by the bandwidth requirements. Each node preferably latches the bus, to avoid long connections. This allows a high speed, but also a relative high latency bus. All nodes have the same priority and arbitration is accomplished in a distributed manner in each node. Each node can insert a packet whenever an end of packet is detected on the bus. While inserting a packet, it stalls the incoming traffic. It is assumed that this simple arbitration is sufficient when the actual bandwidth is not too close to the available bandwidth, and latency is less important. The latter is true for the packet processor, and the former can be achieved by a good choice of the bus topology.

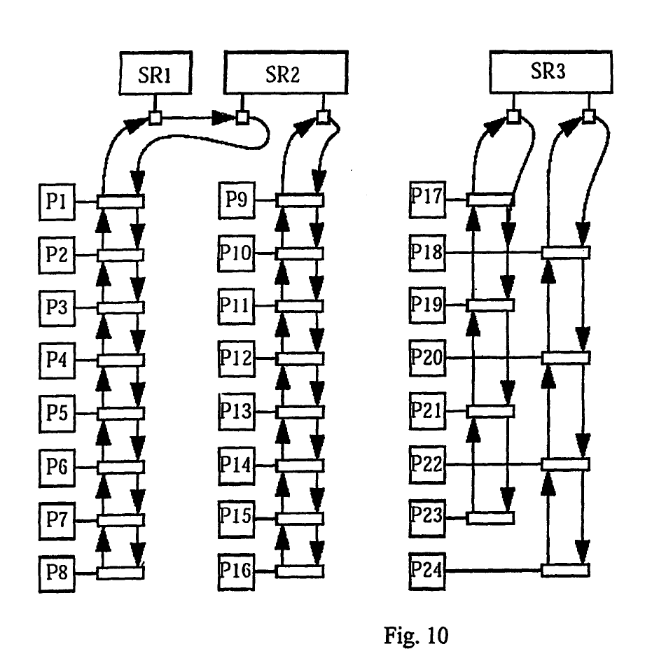

The shared resources may be connected to double bit wide busses as shown schematically in FIG. 10. The processing units P1 to P8 are arranged on one bus and can access shared resources SR1 and SR2, the processing units P9 to P16 are arranged on a second bus and can only access SR2, the processing units P17, 19, 21, 23 to P24 are arranged on a third bus and can only access SR3 and the processing units P18, 20, 22, 24 are arranged on a fourth bus and can only access SR3. Processing nodes communicate with the shared resources by sending messages to each other on the shared bus. Each node on the bus has a unique address. Each node can insert packets on the bus whenever the bus is idle. The destination node of a packet removes the packet from the bus. A contention scheme is provided on the bus to prevent collisions. Each request traveling down the bus is selected by the relevant shared resource, processed and the response is placed on the bus again.

Instead of using the bus type shown in FIG. 10, the buses may be in the form of a ring and a response travels around the ring until the relevant processing unit/shared resource is reached at which point it is received by that processing unit/shared resource.

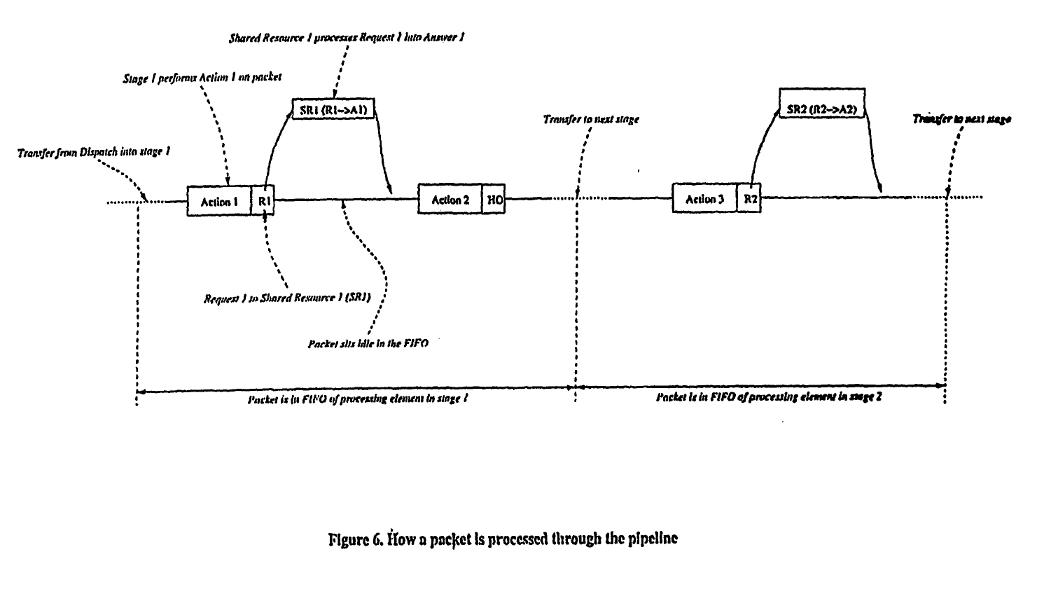

From the above the skilled person will appreciate that a packet entering a processing pipeline 4-6 triggers a chain of actions which are executed on that processing pipeline for that packet. An action is defined as a trace of program (be it in hardware or in software) code that is executed on a processing element during some amount of clock cycles without interaction with any of the shared resources or without communication with the next processing element in the pipeline. An action ends on either a request to a shared resource, or by handing over the packet to the next stage. This sequence of actions, shared resource requests and explicit packet hand-overs to the next stage is shown schematically in FIG. 6 in the form of a flow diagram. A packet head is first delivered from the dispatch unit. The processing element of the processing unit of the first stage of the pipeline performs an action on this head. A request is then made to a shared resource SR1. During the time to answer, the head remains in the associated FIFO memory. When the answer is received a second action is carried out by the same processing element. Accordingly, within one processing element, several of these actions on the same packet can be performed. At the end of the processing for one processing element on one head, the modified head is transferred to the next stage where further actions are performed on it.

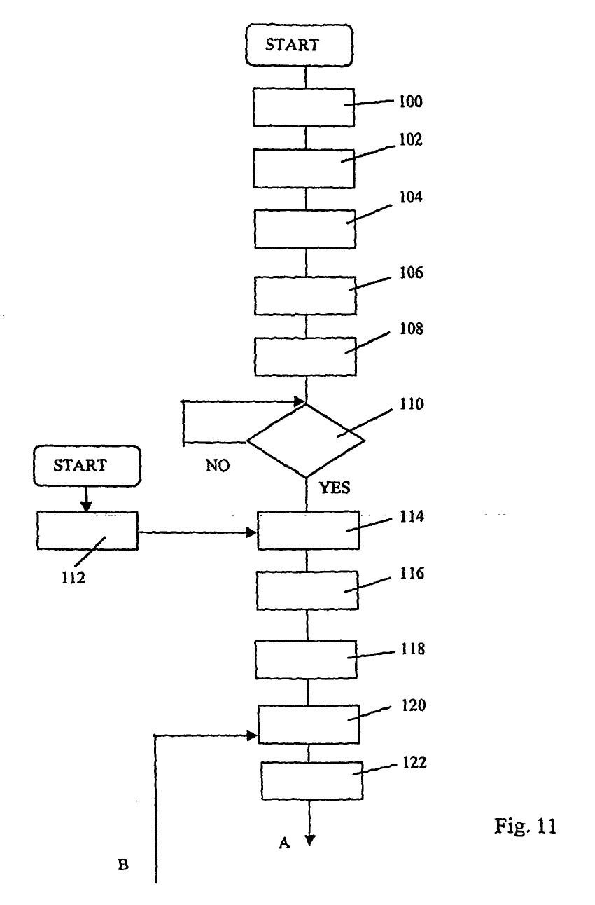

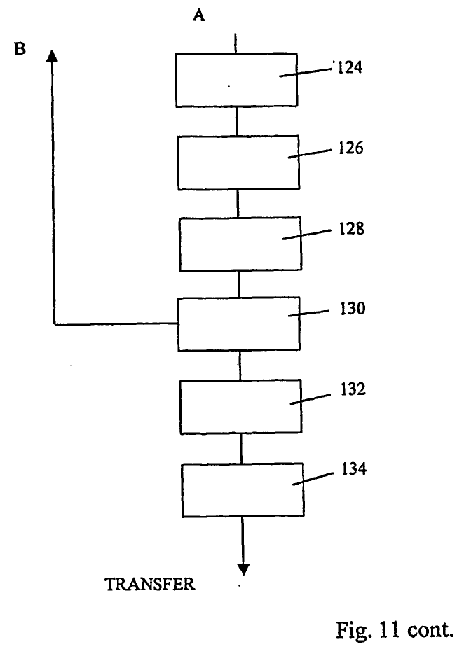

A flow diagram of the processing of a packet by a processing unit in a pipeline is shown schematically in FIG. 11. It will be recalled that within the buffer memory 7, each buffer may be one of the following possible buffer states:
empty
R4P: ready for processing
R4T: ready for transfer
R4PwSRPending: ready for processing after transmission of SR requests
R4TwSRPending: ready for transfer after transmission of SR requests
WaitingLevel: number of outstanding SR requests
relevant bits in the HAF:
Transfer
SRRequest

In step 100, a new packet head is presented at the receive port of a communications engine and if there is a free (empty) buffer location in the memory, the packet head is received and the status of free buffers is accessed via the buffer manager. If a free buffer exists, the head data is sent in step 102 to the memory and stored in step 104 in the appropriate buffer, i.e. at the appropriate memory location. In step 106 the buffer state in the buffer state register is updated by the communication engine from empty to R4P if the head is to be processed (or R4T for packet heads that do not require processing, e.g. dropped and tunneled packet heads). As older packet heads in the buffers are processed and sent further down the pipeline, after some time, the current R4P packet head is ready to be selected.

In step 108, the processing element finishes processing of a previous head and requests a next packet head from the communications engine. The next packet selection is decided in step 110 on the basis of the buffer states contained in the buffer state register. If no R4P packet heads are available then idle is returned by the communications engine to the processor. The processing element will request the same again until a non-idle answer is given.

In step 114 the communications engine accesses the next packet register and sends the next packet head location and the associated task pointer is sent to the processing element. In order for the processing element to get started right away, not only the next packet head location is provided in the answer, also the associated task pointer is given. This data is part of the HAF of the next packet head to be processed and hence requires the cycle(s) of a read to memory. Therefore the communication engine continuously updates in step 112 the new packet register with a packet head location+task pointer tuple so as to have this HAF read take place outside the cycle budget of the processing element.

In step 116, the processing element processing the packet head and updates the HAF fields ‘Transfer’ and ‘SRRequest’. The communications engine monitors the data bus and on the basis of this bus monitoring between the processing element and the memory, the buffer state manager is informed to update the buffer state in step 118. For instance, a head can become R4P or R4T if no SR requests are to be sent or R4PwSRPending or R4TwSRPending if SR request are to be sent.

In step 120 the pending SR request triggers the SR transmit machine after the processing phase to assemble and transmit the SR requests that are listed at the end of the buffer, i.e. the requestIDs list. In step 122 the request IDs are processed in sequence. The indirect type requests require reads from memory. In step 124, for every request that expects an answer back, as opposed to a command, the WaitingLevel counter is increased.

In step 126, upon receipt of an SR answer, the SR receive machine processes the result, and writes in step 128 writing to the memory, more specifically to the buffer location associated with the appropriate packet head. In step 130 the waitingLevel counter is decreased.

Eventually when all requests are transmitted and all replies are received a packet head is set to R4P or R4T in step 132. A first-in-first out approach is taken for the packet head stream in the buffers. In step 134, when the oldest present packet head becomes ‘R4T’ then the transmit machine will output this packet head to the transmit port.

The processing pipelines in accordance with the present invention meet the following requirements:
communication overhead is very low to meet a cycle budget which is very limited
the option of the packets not to be reordered can be supported
the heads stay the same size, shrink or grow when passing through the pipeline as packet headers are kept the same size, stripped off or information is added thereto, respectively; the pipeline always realigns the next relevant header to the processor word boundaries. This makes the first header appear at a fixed location in the FIFO memory 7b . . . 7d, which simplifies the software.
a processing unit is able to read, strip and modify the heads; items which a processing unit is not interested in are transferred to the next stage without any intervention of the processing unit. Thus, parts of the payload carried in the header are not corrupted but simply forwarded.
a processing unit is able to drop a packet.
   processing units are synchronized.

1. A packet processing unit for use in a packet switched network, comprising:
means for receiving a packet in the packet processing unit;
means for adding to a least a first data portion of the packet administrative information including at least an indication of at least one process to be applied to the first data portion;
a plurality of parallel pipelines, each pipeline comprising at least one processing element, and at least one processing element carrying out the process on the first data portion indicated by the administrative information to provide a modified first data portion.

2. A packet processing unit according to claim 1, further comprising a module for splitting each packet received by the packet processing unit into a first data portion and a second data portion;

3. A packet processing unit according to claim 2, further comprising means to deliver the modified first data portion to another processing element.

4. A packet processing unit according to claim 3, wherein the delivery means delivers the first data portion to another processing element only after the process indicated by the administrative information is completed.

5. A packet processing unit according to claim 2, further comprising means to temporarily store the second data portion.

6. A packet processing unit according to claim 5, wherein the temporary storing means is a FIFO memory element.

7. A packet processing unit according to claim 2, further comprising means to add a sequence indication for the received packet to both the first and second data portions.

8. A packet processing unit according to claim 1, wherein each pipeline comprises a plurality of communication engines, each communication engine being linked to a processing element.

9. A packet processing unit according to claim 8, wherein each communication engine is linked to a processing element by a two port memory unit, one port being connected to the communication engine and the other port being connected to the processing element.

10. A packet processing unit according to claim 9, wherein the two port memory is configured as a FIFO as seen from the communication engine connected thereto.

11. A packet processing unit according to claim 10, further comprising a reassembly unit for reassembling the first and second data portions of a packet.

12. A packet processing unit according to claim 8, wherein the communication engine selects a first data portion of a packet for a processing element to process.

13. A packet processing unit according to claim 8, wherein a request for a shared resource from a processing element is transmitted by the communication engine to a shared resource.

14. A method of processing data packets in a packet processing unit for use in a packet switched network, the packet processing unit comprising a plurality of parallel pipelines, each pipeline comprising at least one processing element, comprising:
adding to at least a first data portion of the packet administrative information including at least an indication of at least one process to be applied to the first data portion; and
using at least one processing element, carrying out the process on the first data portion indicated by the administrative information to provide a modified first data portion.

15. A method according to claim 14, further comprising splitting each packet received by the packet processing unit into a first data portion and a second data portion.

16. A method according to claim 15, further comprising delivering the modified first data portion to another processing element.

17. A method according to claim 16, wherein the delivery step includes delivering the first data portion to another processing element only after the process indicated by the administrative information is completed.

18. A method according to claim 15, further comprising temporarily storing the second data portion.

19. A method according to claim 18, wherein the temporary storing step comprises storing in a FIFO memory unit.

20. A method according to claim 15, further comprising adding a sequence indication for the received packet to both the first and second data portions.

21. A method according to claim 15, further comprising reassembling the first and second data portions of a packet.

22. A packet processing unit for use in a packet switched network, comprising:
means for receiving a packet in the packet processing unit;
a module for splitting each packet received by the packet processing unit into a first data portion and a second data portion;
means for processing at least the first data portion; and
means for reassembling the first and second data portions.

23. A packet processing unit according to claim 22, wherein the packet processing unit comprises a plurality of parallel pipelines, each pipeline comprising at least one processing element, the tasks performed by each processing element being organized into a plurality of functions such that there are substantially only function calls and no interfunction calls and that at the termination of each function called by the function call for one processing element the only context is a first data portion.

24. A packet processing unit according to claim 22, further comprising:
means for adding to a least a first data portion of the packet an administrative information including at least an indication of at least one process to be applied to the first data portion; and
a plurality of parallel pipelines, each pipeline comprising at least one processing element, an at least one processing element carrying out the process on the first data portion indicated by the administrative information to provide a modified first data portion.

25. A packet processing unit according to claim 24, further comprising means to deliver the processed first data portion to another processing element.

26. A packet processing unit according to claim 25, wherein the delivery means delivers the first data portion to another processing element only after the process indicated by the administrative information is completed.

27. A packet processing unit according to claim 22, further comprising means to temporarily store the second data portion.

28. A packet processing unit according to claim 27, wherein the temporary storing means is a FIFO memory element.

29. A packet processing unit according to claim 22, further comprising means to add a sequence indication for the received packet to both the first and second data portions.

30. A packet processing unit according to claim 23, wherein each pipeline comprises a plurality of communication engines, each communication engine being linked to a processing element.

31. A packet processing unit according to claim 30, wherein each communication engine is linked to a processing element by a two port memory unit, one port being connected to the communication engine and the other port being connected to the processing element.

32. A packet processing unit according to claim 31, wherein the two port memory is configured as a FIFO as seen from the communication engine connected thereto.

33. A method of processing data packets in a packet processing unit for use in a packet switched network, comprising splitting each packet received by the packet processing unit into a first data portion and a second data portion;
processing at least the first data portion; and
reassembling the first and second data portions.

34. A method according to claim 33, wherein the packet processing unit comprises a plurality of parallel pipelines, each pipeline comprising at least one processing element, the method further comprising: organizing the tasks performed by each processing element into a plurality of functions such that there are substantially only function calls and no interfunction calls and that at the termination of each function called by the function call for one processing element the only context is a first data portion.

35. A method according to claim 33, wherein the packet processing unit comprises a plurality of parallel pipelines, each pipeline comprising at least one processing element, the method further comprising:
adding to at least a first data portion of the packet administrative information including at least an indication of at least one process to be applied to the first data portion; and
an at least one processing element carrying out the process on the first data portion indicated by the administrative information to provide a modified first data portion.

36. A method according to claim 35, further comprising delivering the processed first data portion to another processing element.

37. A method according to claim 36, wherein the delivery step includes delivering the first data portion to another processing element only after the process indicated by the administrative information is completed.

38. A method according to claim 33, further comprising temporarily storing the second data portion

39. A method according to claim 38, wherein the temporary storing step comprises storing in a FIFO memory unit.

40. A method according to claim 33, further comprising adding a sequence indication for the received packet to both the first and second data portions.

41. A packet processing unit for use in a packet switched network, comprising:
means for receiving a packet in the packet processing unit;
a plurality of parallel pipelines, each pipeline comprising at least one processing element, a communication engine linked to the at least one processing element by a two port memory unit, one port being connected to the communication engine and the other port being connected to the processing element.

42. A packet processing unit according to claim 41, wherein the two port memory is configured as a FIFO as seen from the communication engine connected thereto.

43. A method of processing data packets in a packet processing unit for use in a packet switched network the packet processing unit comprising a plurality of parallel pipelines, each pipeline comprising at least one processing element, the method further comprising: organizing the tasks performed by each processing element into a plurality of functions such that there are substantially only function calls and no interfunction calls and that at the termination of each function called by the function call for one processing element the only context is a first data portion.

44. A packet processing unit for use in a packet switched network, comprising:
means for receiving a data packet in the packet processing unit;
a plurality of parallel pipelines, each pipeline comprising at least one processing element for carrying out a process on at least a portion of a data packet
a communication engine connected to the processing element,
at least one shared resource, wherein the communication engine is adapted to receive a request for a shared resource from the processing element and transmit it to the shared resource.
